(19) United States
(12) Patent Application Publication
(10) Pub. No.: US 2013/0081264 A1
(43) Pub. Date: Apr. 4, 2013

(54) METHOD OF FABRICATING SECONDARY BATTERY

(71) Applicants: Shun EGUSA, Kanagawa-ken (JP); Katsuhiro Sato, Kanagawa-ken (JP)

(72) Inventors: Shun EGUSA, Kanagawa-ken (JP); Katsuhiro Sato, Kanagawa-ken (JP)

(73) Assignee: Kabushiki Kaisha Toshiba, Minato-ku (JP)

(21) Appl. No.: 13/615,916

(22) Filed: Sep. 14, 2012

(30) Foreign Application Priority Data
Sep. 29, 2011 (JP) 2011-215707

(51) Int. Cl. H01M 10/058

(52) U.S. Cl. 29/623.5

(57) ABSTRACT

Provided is a method of fabricating a secondary battery including a battery case and an electrode plate set housed in the battery case. The electrode plate set includes positive and negative electrode plates and a separator interposed therebetween. The electrode plate set is impregnated with non-aqueous electrolyte. The method includes the steps of: replacing air in the battery case with gas having an Ostwald solubility coefficient of 2.0 or more in the non-aqueous electrolyte; reducing the pressure in the battery case after the replacement with the gas; and introducing the non-aqueous electrolyte into the depressurized battery case.

### CROSS-REFERENCE TO RELATED APPLICATIONS

This application is based upon and claims the benefit of priority from Japanese Patent Application No. 2011-215707, filed on Sep. 29, 2011; the entire contents of which are incorporated herein by reference.

### FIELD

The embodiments relate to a method of fabricating a secondary battery.

### BACKGROUND

Recently, in electronics such as audio visual equipment, PCs, and mobile communication devices, a trend toward portable or cordless versions has been rapidly accelerated. In power sources for driving such electronics, non-aqueous electrolyte secondary batteries represented by lithium secondary batteries are becoming the mainstream. Non-aqueous electrolyte secondary batteries are small, light, high-capacity rechargeable batteries which are capable of being quickly charged and high in both of volume energy density and weight energy density.

Moreover, with the diversification of electronics which use non-aqueous electrolyte secondary batteries, there have been demands for higher-capacity non-aqueous electrolyte secondary batteries. Accordingly, the densities of active materials of non-aqueous electrolyte secondary batteries have increased, and the degree of tightness among positive and negative electrode plates and a separator has increased. As a result, the time needed for the infiltration of non-aqueous electrolyte has become longer.

### BRIEF DESCRIPTION OF THE DRAWINGS

FIG. 1 is a process flow diagram showing a procedure for a secondary battery fabrication method according to an embodiment.

### DETAILED DESCRIPTION

A secondary battery fabrication method according to an embodiment is a method of fabricating a secondary battery including a battery case and an electrode plate set housed in the battery case. The electrode plate set includes positive and negative electrode plates and a separator interposed therebetween. The electrode plate set is impregnated with non-aqueous electrolyte. The secondary battery fabrication method includes the steps of: replacing air in the battery case with gas having an Ostwald solubility coefficient of 2.0 or more in the non-aqueous electrolyte; reducing the pressure in the battery case after the replacement with the gas; and introducing the non-aqueous electrolyte into the depressurized battery case.

Hereinafter, the secondary battery fabrication method according to the embodiment of the present invention will be described in detail with reference to the drawing.

In the secondary battery fabrication method of this embodiment, a battery cell is fabricated first, and then non-aqueous electrolyte is introduced into the battery cell, followed by closing the battery cell. The battery cell refers to the battery case having the electrode plate set enclosed therein.

A method of fabricating the battery cell will be briefly described. First, the battery case and the electrode plate set are fabricated, respectively. The electrode plate set is formed by interposing the separator between the positive and negative electrode plates and rolling these three members in a flat shape. It should be noted that the electrode plate set is not limited to a flat shape. The electrode plate set may be of a cylindrical shape, or the electrode plates may be stacked.

Each of the positive and negative electrode plates is fabricated by applying active material paste to metal foil, followed by drying, rolling, and the like. The separator is a sheet made of an insulative resin. Before the electrode plate set is placed in the battery case, the separator is interposed between the positive and negative electrode plates. The set of positive and negative electrode plates having the separator interposed therebetween is rolled to be placed in the battery case. Then, a top cover is attached to an opening of the battery case. At this stage, a fill port is left in the top cover.

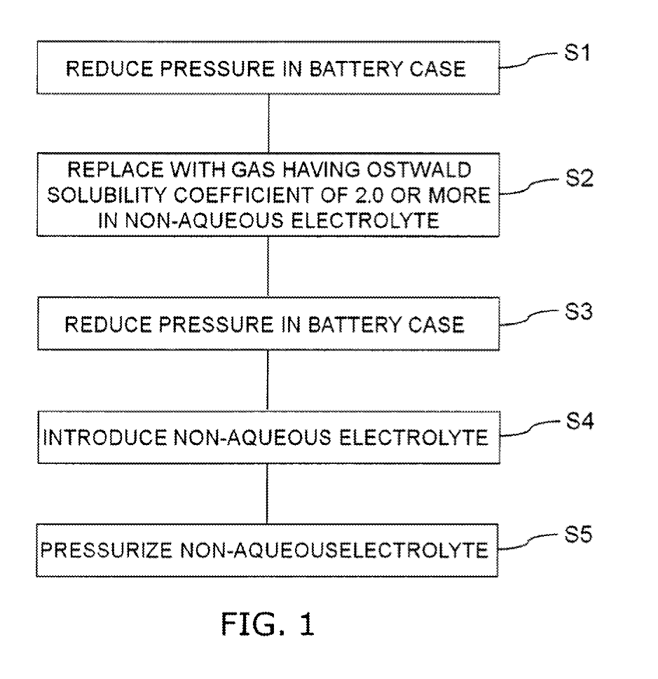

Next, the non-aqueous electrolyte is introduced into the battery case in this state according to a procedure such as shown in FIG. 1. First, the pressure in the battery case having the electrode plate set inserted therein is reduced using, for example, a vacuum pump or the like (first step S1).

At this time, in a state in which the battery case is placed in a depressurized chamber, the pressure in the battery case is reduced. It should be noted that for the depressurization of the battery case, only the pressure in the battery case may be reduced. Moreover, in the depressurization of the battery case, the pressure in the battery case is desirably reduced to such an extent that air in gaps between the positive electrode plate, the negative electrode plate, and the separator and between the battery case and the electrode set can be removed.

Next, air in the battery case is replaced with gas having an Ostwald solubility coefficient of 2.0 or more in the non-aqueous electrolyte (second step S2). In this embodiment, carbon dioxide, which has an Ostwald solubility coefficient of 2.8 in the non-aqueous electrolyte, is introduced into the battery case to carry out replacement. It should be noted that though replacement with carbon dioxide is carried out in this embodiment, the present invention is not limited to this. Any gas may be used as long as the gas has an Ostwald solubility coefficient of 2.0 or more and does not chemically react with either of the electrode set and the non-aqueous electrolyte.

The reason for using gas having an Ostwald solubility coefficient of 2.0 or more is as follows: in the case where gas having an Ostwald solubility coefficient of 2.0 or more exists in the gaps between the positive electrode plate, the negative electrode plate, and the separator and between the battery case and the electrode set, the gas dissolves in the non-aqueous electrolyte when the non-aqueous electrolyte is introduced into the battery case, and the non-aqueous electrolyte therefore easily enters the gaps. In other words, wettability to the non-aqueous electrolyte improves. This reduces the time needed to introduce the non-aqueous electrolyte.

When carbon dioxide is introduced to carry out replacement, air in the battery case can be replaced with carbon dioxide by creating an atmosphere of carbon dioxide in the chamber in which the battery case is placed. It should be noted that when carbon dioxide is introduced into the battery case, the carbon dioxide may be introduced directly into the battery case to carry out replacement.

Moreover, when replacement with carbon dioxide is carried out, it is desirable to ensure that the carbon dioxide reach the gaps between the positive electrode plate, the negative electrode plate, and the separator and between the battery case and the electrode set. Accordingly, it is recommended to carry out replacement with an atmosphere containing 75 volume % or more, preferably 95 volume % or more, of carbon dioxide. The above-described replacement with an atmosphere containing 75 volume % or more, preferably 95 volume % or more, of carbon dioxide enables the gaps between the positive electrode plate, the negative electrode plate, and the separator and between the battery case and the electrode set to be supplied with carbon dioxide by an amount needed to improve wettability. Further, electrolyte filling can be carried out in a shorter time.

Further, after the replacement of air in the battery case with carbon dioxide, the battery case may be returned to a depressurized state again, followed by another replacement of air in the battery case with carbon dioxide. Moreover, this may be repeated multiple times. This can further ensure that carbon dioxide reach the gaps between the positive electrode plate, the negative electrode plate, and the separator and between the battery case and the electrode set.

Next, the pressure in the battery case is reduced (third step S3). This depressurization is desirably carried out with such a reduced pressure that extra carbon dioxide is removed while the amount of carbon dioxide needed to improve wettability to the non-aqueous electrolyte is being maintained. Accordingly, it is recommended to carry out depressurization such that the following formula (1) is satisfied:

P×t≧−400 (1)

where P represents the reduced pressure as relative pressure (kPa), and t represents depressurization time in minutes.

Thus, the amount of carbon dioxide which dissolves in the non-aqueous electrolyte can be reduced as far as possible while wettability to the non-aqueous electrolyte is being maintained.

When the battery cell is degraded, carbon dioxide is generated to dissolve in the non-aqueous electrolyte. When the concentration of carbon dioxide exceeds the saturation solubility thereof, carbon dioxide remains gaseous to expand the battery cell. Accordingly, as in this embodiment, by, as far as possible, reducing the amount of carbon dioxide which dissolves in the non-aqueous electrolyte, the amount of carbon dioxide which can dissolve in the non-aqueous electrolyte can be increased. As a result, the expansion of the battery cell can be made small.

Next, the non-aqueous electrolyte is introduced into the battery case (fourth step S4). At this time, the non-aqueous electrolyte is supplied from outside the chamber. Accordingly, a difference occurs between the pressure in the battery case and the pressure of the non-aqueous electrolyte under atmospheric pressure. Accordingly, the non-aqueous electrolyte can be introduced by utilizing the difference in pressure. Moreover, in the gaps between the positive electrode plate, the negative electrode plate, and the separator and between the battery case and the electrode set, wettability is improved by carbon dioxide. This makes it possible to more quickly introduce the non-aqueous electrolyte without leaving spaces. Further, since the excess of carbon dioxide over the amount of carbon dioxide needed to improve wettability is reduced as far as possible, carbon dioxide existing in a gaseous state can be reduced. Thus, it becomes possible to introduce the non-aqueous electrolyte while reducing the occurrence of bubbles and the like.

Next, pressure is applied to the non-aqueous electrolyte to fill the battery case with the non-aqueous electrolyte (fifth step S5). The non-aqueous electrolyte is introduced by utilizing differential pressure between inside and outside of the battery case. However, in some cases, this difference in pressure may be insufficient to fill the entire battery case with the non-aqueous electrolyte. For this reason, the non-aqueous electrolyte is introduced under pressure so that a sufficient amount of non-aqueous electrolyte may be introduced into the entire battery case. Moreover, the application of pressure to the non-aqueous electrolyte enables the non-aqueous electrolyte to be quickly introduced.

In the application of pressure to the non-aqueous electrolyte, it is recommended to apply pressure such that the pressure may be 0.05 to 0.5 MPa. Pressures less than 0.05 MPa are too low to fill the battery case with the non-aqueous electrolyte, and therefore less effective. On the other hand, pressures more than 0.5 MPa impose loads on the gaps between the positive electrode plate, the negative electrode plate, and the separator and between the battery case and the electrode set, and may therefore cause breakage. Accordingly, pressure is applied such that the relative pressure may be 0.05 to 0.5 MPa.

The inventors have carried out electrolyte filling according to examples 1 and 2 of this embodiment and a comparative example by experiment, and have compared times needed to carry out the electrolyte filling.

First, an electrode plate set which includes glass slides prepared as substitutes for the positive and negative electrode plates and a polyethylene-based separator as the separator interposed therebetween is set in a pressure-resistant container. The pressure-resistant container to be used can be depressurized and allows the non-aqueous electrolyte to be introduced into the pressure-resistant container. Further, the electrode plate set is visible from outside the pressure-resistant container.

In example 1, electrolyte filling was carried out according to the electrolyte filling process of this embodiment. Specifically, first, the pressure in the pressure-resistant container having the electrode set inserted therein was reduced to −0.1 MPa. Next, air in the pressure-resistant container was replaced with carbon dioxide, which has an Ostwald solubility coefficient of 2.8, and the pressure in the pressure-resistant container returned to atmospheric pressure. Further, three cycles of a depressurized state and a state of atmospheric pressure created by the introduction of carbon dioxide were performed. Next, the pressure in the pressure-resistant container was reduced to −0.1 MPa, and the pressure-resistant container was left alone for five minutes. After that, the non-aqueous electrolyte under atmospheric pressure was introduced into the pressure-resistant container, and pressurization was carried out at 0.1 MPa. As a result, it took approximately 10 minutes to impregnate the electrode plate set to a distance of 60 mm.

In example 2, the electrolyte filling process was carried out to the step (second step S2) of carrying out replacement with carbon dioxide under conditions similar to those in example 1. After that, the non-aqueous electrolyte was introduced without depressurization, and pressurization after the electrolyte filling was not carried out. As a result, it took approximately 2.5 times as long a time as in example 1 to impregnate the electrode plate set to a distance of 60 mm.

The comparative example was carried out under the same conditions as those in example 1 except for the fact that non-aqueous electrolyte was introduced without the replacement with carbon dioxide and then the pressure-resistant container was left in a state of atmospheric pressure. As a result, it took approximately four times as long a time as in example 1 to impregnate the electrode plate set to a distance of 60 mm.

Accordingly, a comparison of example 1 of this embodiment and the comparative example proved that the replacement with carbon dioxide enables the electrolyte filling process to be completed in a short time. Moreover, a comparison of examples 1 and 2 revealed that in the case where depressurization after the replacement with carbon dioxide and pressurization after the introduction of the non-aqueous electrolyte are carried out, the electrolyte filling process can be completed in a shorter time.

As described in detail above, in the electrolyte filling process of this embodiment, air in the battery case is replaced with gas having an Ostwald solubility coefficient of approximately 2.0 or more, and then the pressure in the battery case is reduced, followed by the introduction of the non-aqueous electrolyte. This makes it possible to introduce the non-aqueous electrolyte in a shorter time.

Further, depressurization before the introduction of the non-aqueous electrolyte and the application of pressure to the non-aqueous electrolyte after the introduction of the non-aqueous electrolyte make it possible to carry out electrolyte filling in a shorter time.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A method of fabricating a secondary battery comprising a battery case and an electrode plate set housed in the battery case, the electrode plate set comprising positive and negative electrode plates and a separator interposed therebetween, the electrode plate set being impregnated with non-aqueous electrolyte, the method comprising the steps of:
replacing air in the battery case with gas having an Ostwald solubility coefficient of 2.0 or more in the non-aqueous electrolyte;
reducing pressure in the battery case after the replacement with the gas; and
introducing the non-aqueous electrolyte into the depressurized battery case.

2. The method according to claim 1, wherein a reduced pressure to which the pressure in the battery case is reduced is a reduced pressure which satisfies the following formula (1):
P×t≧−400 (1)
where P represents the reduced pressure as relative pressure, and t represents depressurization time.

3. The method according to claim 1, further comprising, after the introduction of the non-aqueous electrolyte, the step of applying pressure to the non-aqueous electrolyte.

4. The method according to claim 3, wherein the pressure applied to the non-aqueous electrolyte is 0.05 to 0.5 MPa.

5. The method according to claim 1, wherein the replacing step is performed to create an atmosphere containing 75 volume % or more of the gas with which the air in the battery case is replaced.

6. The method according to claim 1, wherein the gas is carbon dioxide.
